(19) United States
(12) Patent Application Publication
(10) Pub. No.: US 2022/0191381 A1
(43) Pub. Date: Jun. 16, 2022

(54) DYNAMIC TRANSFER FUNCTION FOR REVERSIBLE ENCODING

(71) Applicant: Contrast, Inc., Albuquerque, NM (US)

(72) Inventor: Willie C. Kiser, Albuquerque, NM (US)

(21) Appl. No.: 17/547,616

(22) Filed: Dec. 10, 2021

Related U.S. Application Data
(60) Provisional application No. 63/124,484, filed on Dec. 11, 2020.

(51) Int. Cl. H04N 5/235; H04N 5/265

(52) U.S. Cl. CPC H04N 5/2355; H04N 5/265; H04N 5/2351

(57) ABSTRACT

The invention provides methods and cameras that digitize scene luminance using a transfer function with a shape that can be changed during use. The transfer function may default to a logarithmic transfer function with a shape that can be changed “on-the-fly”. For example, a user may consider ambient light levels and select a transfer function with steeper or shallower initial slope to adjust what amount of variation in illumination can be encoded. A camera may include an image sensor, a processing device that receives pixel values from the image sensor, and a module on the processing device that converts the pixel values to digital values according to a transfer function, wherein the transfer function defines output digital values for corresponding input values according to a function that can be changed within the camera.

### TECHNICAL FIELD

The disclosure relates to high dynamic range video and related methods and devices.

### BACKGROUND

The human eye is capable of detecting variations in brightness over a dynamic range of about 10,000:1. Photographic images typically are incapable of replicating the dynamic range visible to the human eye. Some cameras preserve the dynamic range of a scene digitally by storing pixel brightness values using, for example, 14 bits per pixel per color. A problem, however, is that human visual perception has a non-linear relationship to brightness. As a result, a linear translation of scene luminance into an encoded brightness may create a digital image that is too dark in the dark regions (under exposed) or too bright and washed out in the bright regions (over exposed). Post-processing of still images can correct for some of the differences in perceived dynamic range and conventional technology, mostly in the form of software, has improved the ability of still images to better reflect reality.

Despite some progress in the translation of still images to mimic the dynamic range detectable by the human eye, moving images remain an intractable problem. Early research in technologies, such as cathode ray tubes, suggested that video signals should be digitized using a non-linear power law known as a gamma function, using 8 bits per pixel for brightness. Accordingly, much contemporary digital video for consumer equipment and computer graphics uses 8 bit encoding. Existing television, cable, and satellite channels typically operate with 8 bit signals defining the standard dynamic range. Thus, while some modern cameras capture images at a higher dynamic range, video is typically broadcast and displayed at 8 bit standard dynamic range. There is a need in the art for high dynamic range video that captures the full range detectable by human perception.

### SUMMARY

The invention provides digital video methods and cameras that digitize scene luminance using a transfer function designed to enhance and/or preserve parameters in the conversion of an HDR pixel stream to an SDR image. According to the invention, the shape of the transfer function curve can be changed on the camera, during use, by software or by the user (i.e., “on the fly”). The transfer function may be any non-linear function, including but not limited to, a gamma function or other logarithmic function. However, in any case methods and devices of the invention allow a user (or software) to change the shape of the transfer function during use. For example, at low luminance values, the slope of a transfer function essentially dictates the amount of variation in illumination, or contrast, that can be encoded. Using the present invention, a person or camera software can select a transfer function with steeper or shallower initial slope based on the brightness of ambient light. In another example, a camera can display available transfer functions on a preview monitor while filming is occurring. The user can change the transfer function during filming, which cause a corresponding change in the display. This can occur while filming live, in real-time, and a user may even preview the change on a preview monitor of the camera while the change is being implemented.

An important feature of the invention is that logarithmic and other (e.g., pseudo-logarithmic) transfer functions provide a way to encode a high dynamic range (HDR) video into an standard dynamic range (SDR) bit space (e.g., 8 bits per color per pixel) while preserving luminance information over a greater dynamic range than is found with traditional SDR hardware. A user can alter the slope and shape of the transfer function to assign a larger number of output pixel values to selected portions of an image (e.g., where there is the most detail or contrast) and a smaller number of output pixel values to regions that are less relevant to the chosen image(s). Another important feature of the invention is that the HDR video is encoded by a reversible transfer function that can be changed on-the-fly while filming or otherwise processing video. The transfer function is dynamic in that the shape of the transfer can change while filming or processing video. Methods and devices of the invention use frame-independent pipeline processing of pixel values to accomplish HDR and encoding in real time. Because pixel values are processed as they stream through a pipeline without storing full image frames on-chip (waiting for frame catch-up) for HDR or transfer function processing, the HDR and transfer functions are applied in real time.

The invention provides methods for the real-time, dynamic reversible encoding of high dynamic range videos, allowing high dynamic range videos to be broadcast through standard dynamic range channels. A high-dynamic range video signal is streamed through a pipeline that processes the video stream in a pixel-by-pixel manner as the pixels stream through the pipeline. The pipeline includes a dynamic transfer function that can decrease a number of bits of each pixel to a standard dynamic range, in a reversible manner, to allow the high dynamic range video to be transmitted over existing, standard dynamic range channels. The transfer function may also be edited or changed while the methods and devices operate. For example, the transfer function may be switched between pre-sets, or the transfer function may be edited by a user in a free-form manner. For example, a camera may have a touch screen that displays a shape of a transfer function and allows a user to touch-and-drag the shape to thereby re-define the transfer function accordingly. The transfer function may be, for example, by default an opto-electrical transfer function (OETF) such as S-Log that converts pixels from greater than 8 bits per color to at most 8 bits per color, and the inverse function may be applied by a receiver such as a display device to display the video with high dynamic range.

Embodiments of the disclosure include hardware architecture to implement the dynamic transfer function. For example, in some embodiments, a device includes a processing device such as a field-programmable gate array (FPGA) or an application-specific integrated circuit (ASIC) that implements the pipeline processing including formation of HDR video and application of the transfer function. The processing device processes pixels in a pipeline in real-time to form the high dynamic range video. Pipeline processing of the pixels as they stream through the processing device provides a high dynamic range (HDR) pixel stream and also uses the dynamic transfer function to decrease the number of bits per pixel as the pixels stream through the pipeline in a frame-independent manner, allowing the live video to be captured and transmitted (or broadcast) for display in real-time. However, the device may also include a user interface, e.g., one or more input/output (I/O) devices (such as a touch screen or selected switch) that allows the user to redefine the transfer function. The device may further include a control chip (e.g., an Intel or AMD processor) that operates a software module to create new transfer function parameters based on the user definition/selection. The control chip passes the transfer function parameters to a transfer function module on the processing device, which module immediately begins applying the transfer function according to the updated parameters without interrupting the pipeline processing. Other hardware architectures are included within the scope of the invention (e.g., all general purpose chip, all FPGA, the use of graphics processing units, or combinations thereof). Because the transfer function reversibly decreases the number of bits per pixel, methods are useful for reversibly encoding live high dynamic range video signal for transmission over standard dynamic range channels. Because the transfer function can be redefined on-the-fly, and even drawn into a custom shape, cameras and methods of the invention offer great control over capturing high dynamic range images despite varying or unpredictable ambient lighting conditions.

In certain aspects, the invention provides a method that includes receiving an input signal onto a processing device and converting the input signal into outputs according to a transfer function resident on the processing device. The transfer function defines a relationship from inputs to output values and the transfer function relationship can be re-defined within the processing device. The transfer function relationship may be logarithmic by default. For example, the logarithmic relationship may include output=constant*(input)\hat{ }gamma, and the processing device may be able to receive a new gamma (e.g., from user input) to redefine the relationship. In certain camera embodiments, the input signal comprises pixel values received from an image sensor coupled to the processing device. Preferably, the pixel values may be received as an analog signal and the transfer function may provide an analog/digital converter.

In some embodiments, the processing device is coupled to a control processor housed within a video camera comprising at least one input/output (I/O) device by which a user can provide input re-defining the transfer function. The control processor passes transfer function parameters to the processing device, and the processing device converts an analog video input signal to digital outputs according to the transfer function parameters. The processing device may be a field-programmable gate-array (FPGA), and the video camera may include a lens and one or more image sensors coupled to the FPGA (or the same PCB as the FPGA), and the control processor may include a software module for interacting with the user via the I/O device to redefine the transfer function. The method may include re-defining the transfer function multiple times while the processing device is continuously streaming a live video. The transfer function may be re-defined according to logic on the processing device that reads an ambient light level and automatically adjusts the transfer function definition according to the light level. Preferably, the transfer function is an optical-electrical transfer function that receives scene luminance as the input signal and outputs 8-bit pixel values. The method may further include re-defining the transfer function according to user input to allocate a greater range of output pixel values across a range of low-luminance input values.

The method may be implemented by a video camera comprising an input/output (I/O) device (e.g., selection knob or touch screen) by which a user may re-define the transfer function while the video camera is continuously capturing a live video. The camera may display, and receive a selection of, a pre-selected set of curves for selection by the user. For example, the preselected set of curves may include one or more of ITU-R BT-709, S-Log3, SMPTE ST.2084, and a hybrid Log-Gamma curve. Upon selection of one curve by the user, the video camera implements the transfer function according to the selected curve. In some embodiments, a user may custom-define the transfer function, for example, where the I/O is a screen on the video device or a connection to a user terminal on which the user draws or edits a curve.

For HDR video embodiments, the method may be performed by a high-dynamic range (HDR) camera that includes the processing device. HDR video embodiments of the method may include receiving—simultaneously through at least one asymmetric beamsplitter and multiple image sensors in the camera—multiple image inputs that are optically identical except for light level and merging—within a pipeline on the processing device—the multiple image inputs in frame-independent manner to form a real-time HDR video. Preferably, the converting according to the transfer function is performed in a frame-independent manner within the pipeline.

Aspects of the invention provide a camera that includes at least one image sensor, a processing device that receives pixel values from the image sensor, and a module on the processing device that converts the pixel values to digital values according to a transfer function, wherein the transfer function defines output digital values for corresponding input values according to a function that can be changed within the camera. Preferred embodiments of the camera include an HDR camera that uses at least one asymmetric beam splitter and multiple image sensors to simultaneously obtain multiple images signals that are identical except for light level. In some embodiments, the transfer function relationship is logarithmic by default and includes output=constant*(input)\hat{ }gamma, and the processing device can receive a new gamma to redefine the relationship. The input signal may comprise an analog video signal. The processing device (e.g., FPGA or ASIC) may be coupled to a control processor housed within the camera. The camera may include at least one input/output (I/O) device (such as a switch or a touch screen) through which a user can interface with the control processor. In such embodiments, the control processor may receive input from the user re-defining the transfer function, with the result that the input signal is converted to the outputs on the processing device under control of the control processor. The control processor may include a software module for interacting with the user via the I/O device to re-define the transfer function. In some embodiments, the camera is operable to redefine the transfer function multiple times while the processing device is continuously streaming a live video. In certain embodiments, the camera comprises hardware, e.g., a light meter, that allows the camera to redefine the transfer function according to logic on the processing device so as to automatically adjust the transfer function definition. Such auto-adjusting features have application in any environment in which brightness and/or contrast changes (e.g., security cameras, autonomous vehicles, etc.). This allows the HDR-to-SDR conversion to occur with optimal resolution.

In some embodiments, the transfer function is an optical-electrical transfer function that receives scene luminance as the input signal and outputs 8-bit pixel values. The camera may be operable to redefine the transfer function according to user input to allocate a greater range of output pixel values across a range of low-luminance input values. The camera may include an I/O device that displays a pre-selected set of curves for selection by the user. For example, the curves may include some combination of ITU-R BT-709, S-Log3, SMPTE ST.2084, and a hybrid Log-Gamma curve. Upon selection of one curve by the user, the camera implements the transfer function according to the selected curve. The camera may include an input/output (I/O) device by which a user may custom-define the transfer function. For example, the user custom-defines the transfer function through a screen on the camera on which screen the user draws or edits a curve.

In some embodiments, the processing device is coupled to a control chip communicating with an input/output (I/O) device. The control chip includes a software module that passes user-defined transfer function parameters to the processing device (e.g., FPGA). The processing device converts an analog scene luminance input signal to digital outputs according to the user-defined transfer function parameters.

In HDR embodiments, the camera may include at least one asymmetric beamsplitter that splits an image-forming beam onto multiple image sensors to thereby receive multiple image inputs that are optically identical except for light level. For HDR, the camera may merge—within a pipeline on the processing device—the multiple image inputs in frame-independent manner to form a real-time HDR video. Preferably the converting according to the transfer function is performed in a frame-independent manner within the pipeline.

Aspects of the disclosure provide a method for image enhancement. The method includes obtaining input image pixel data; identifying one or more portions of said image for enhancement; modulating a transfer function to produce output pixel data in which said portions are assigned a larger number of output pixel values and one or more remaining portions are assigned a smaller number of output pixel values; and displaying said image.

Aspects of the disclosure provide a method of mapping high dynamic range (HDR) input data to a standard dynamic range (SDR) display. The method includes selecting one or more image parameters from HDR video input and manipulating a transfer function to map said parameters to an SDR display, wherein said parameters have increased bit depth with respect to non-selected image parameters.

### BRIEF DESCRIPTION OF THE DRAWINGS

FIG. 1 diagrams a method using a dynamic transfer function.

FIG. 2 describes exemplary transfer functions that may be used with the invention.

FIG. 3 shows a video camera of the invention.

FIG. 4 shows the circuit board of the camera.

FIG. 5 shows an optical splitting system.

FIG. 6 shows a pipeline on the processing device with a dynamic transfer function.

FIG. 7 shows operation of a sync module to synchronize the pixel values.

FIG. 8 illustrates how the pixel values are presented to a kernel operation.

FIG. 9 shows a display on an I/O device with a pre-selected set of curves.

FIG. 10 shows a touch screen on which a user may custom-define a transfer function.

### DETAILED DESCRIPTION

The invention provides methods and cameras that digitize scene luminance using a transfer function with a shape that can be changed during use. The transfer function may default to a logarithmic transfer function with a shape that can be changed “on-the-fly”. For example, a user may consider ambient light levels and select a transfer function with steeper or shallower initial slope to adjust what amount of variation in illumination can be encoded. A camera may include an image sensor, a processing device that receives pixel values from the image sensor, and a module on the processing device that converts the pixel values to digital values according to a transfer function, in which the transfer function defines output digital values for corresponding input values according to a function that can be changed within the camera. The disclosure provides methods and devices that apply a dynamic OETF (optic-electro transfer function) to a stream of pixels, to convert a video stream with for example more than 8 bits per pixel per color to a video stream with 8 bits per pixel per color. The OETF may define, by default, a modified gamma function, such as may be used in an S-Log function, but in which the function is user-modifiable or may be dynamically changed during use by a control system. Methods may further include applying the inverse EOTF at the other end of the transmission to convert, e.g., the 8 bits per color video signal back into a signal with greater than 8 bits per color.

For example, a video stream may have 14 bits per color. Methods of the disclosure apply a dynamically-adjustable transfer function to that stream (preferably in a pipeline process, pixel-by-pixel) to convert each pixel to 8-bits per color. Then the 8-bit video signal may be sent via a standard 8-bit television, cable, or satellite channel to a receiver, where the receiver would apply an inverse of the transfer function to produce a 14-bit signal which could then be displayed on a 14-bit display. Thus, methods and devices of the disclosure are useful for transmitting HDR video over standard TV channels.

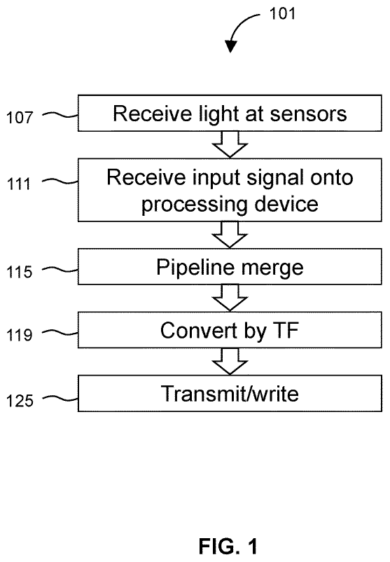

FIG. 1 diagrams a method 101 for reversible encoding using a dynamic transfer function. In HDR camera-based embodiments, the method 101 is performed by an HDR camera that includes a processing device, such as an FPGA or ASIC. The method 101 includes receiving 107 light through at least one asymmetric beamsplitter and multiple image sensors in the camera to simultaneously form multiple image inputs that are optically identical except for light level. Through a connection from the sensors to the processing device, the processing device receives 111 an input signal comprising the multiple image inputs that are optically identical except for light level. A pipeline on the processing device is used to merge 115 the multiple image inputs in frame-independent manner to form a real-time HDR video. A dynamic transfer function in the pipeline converts 119 the input signal to outputs. The transfer function conversion is performed in a frame-independent manner within the pipeline. Specifically, the input signal is converted 119 into outputs according to the transfer function resident on the processing device. The transfer function defines a relationship from inputs to output values. The transfer function is dynamic and the transfer function relationship can be re-defined within the processing device.

The invention comprises the dynamic nature of the transfer function. The input signal, be it video, audio, etc., is processed by the transfer function. Typically, the transfer function may be used to encode the signal, to assign a certain number of bits per quantum of signal. For example, for images and videos, the transfer function can assign a number (e.g., 8) of bits per color per pixel.

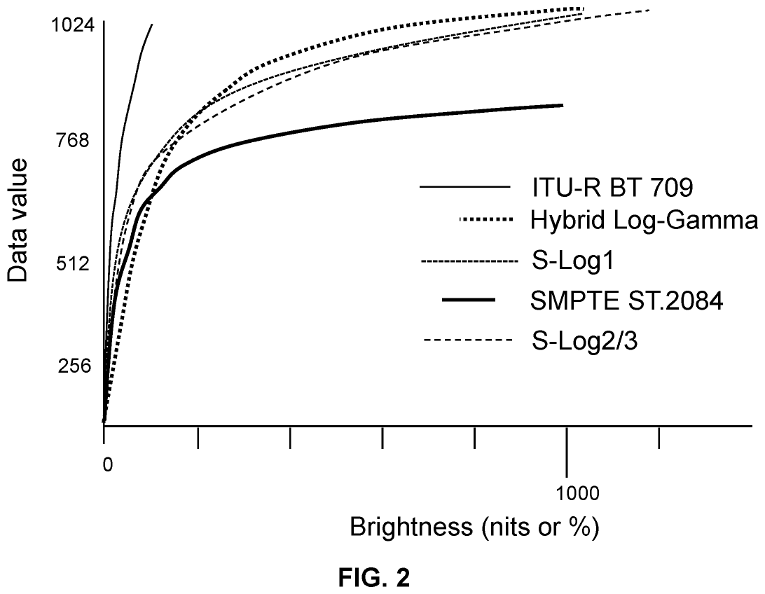

FIG. 2 describes exemplary transfer functions that may be used with methods and devices of the disclosure. The depicted curves operate as opto-electrical transfer functions and are used to carry the full range of the sensor-captured HDR signal through to subsequent processes (except ITU-R BT 709, sometimes called “Rec 709”, which only captures and encodes a limited percentage of brightness, e.g., is only standard dynamic range or SDR). In some embodiments, the method 101 or a camera defaults to a reversible logarithmic transfer function such as Slog (e.g., S-Log1, S-Log2, or S-Log3). Thus the method 101 may use the S-Log1 transfer function shown by default. Compared to the ITU 709 curve, the S-log transfer functions cover a much greater range of brightness, giving brighter signals across the 1024 data values as depicted. The invention includes the ability to edit, change, or adjust the transfer function on the fly during use. For example, the depicted curves may actually be displayed on a preview monitor on a digital video camera—while the camera is taking video. A user may be able to select one of the other transfer functions while still capturing video, and have the camera switch to the selection without interrupting video capture. With reference to the depicted curves, in some embodiments the transfer function relationship is logarithmic by default and the logarithmic relationship may include output=constant*(input)\hat{ }gamma. One way that the transfer function may be dynamic is that the processing device may receive a new gamma to redefine the relationship. For example, a device such as a camera or a video-editing software plug-in may allow a user to select a gamma value or type in a gamma value, and have the logarithm updated to the selected transfer function. Preferably, the transfer function 423 provides an opto-electrical transfer function (OETF) such as an S-Log function.

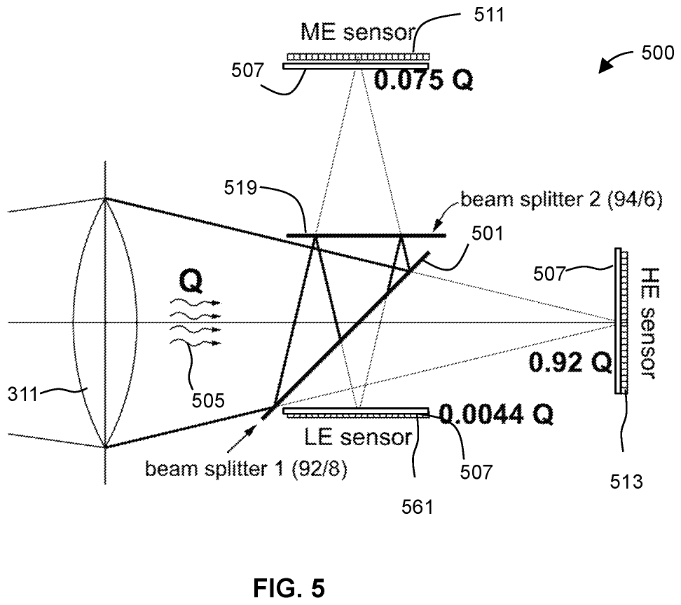

A benefit of the transfer functions is that they can be reversible, such that the outputs can be reverted to the input signal by application of an inverse function to the transfer function. For example, the dynamic transfer function may be applied in an HDR video camera to encode a signal, and a receiver—such as an HDR television or computer with an HDR monitor—may use the inverse function to display the HDR video. The inverse function may be used and provided for use by a receiver to convert the SDR video stream into an HDR video stream, e.g., where the receiver comprises a high-dynamic range display device. The ITU-R BT 709 curve was designed to produce a uniform perception of video noise in an analog signal. However, in quantizing a video signal, it may be more important to avoid contouring and match the human visual systems brightness perception than to avoid noise. To avoid contouring, detecting the difference between adjacent levels is important and is governed by Weber's law, which states that detectable difference in brightness is proportional to the brightness. Weber's law suggests that a logarithmic transfer function optimizes dynamic range while rendering quantization steps imperceptible. Transfer functions according to the disclosure extend dynamic range with a smooth curve. Those functions at low brightness values are (by design) very similar to the Rec 709 curve. Over relevant ranges, preferred transfer functions approximate logarithmic curves. Transfer functions of the disclosure preferably do not result in visible contouring. Furthermore, if the peak brightness of a display using the proposed OETF is approximately a few hundred cd/rn2, then the OETF approximately corresponds to the sensitivity of the eye. Research suggests that an 8 bit version of such a transfer function should be able to produce a higher dynamic range image without visible artifacts. It should be noted that an 8 bit HDR signal would include some exposure latitude to support post processing such as grading. Application of an 8 bit transfer function via methods and devices of the disclosure will allow a higher dynamic range image to be transferred to a display via an 8 bit interface. For background, see UK Patent Publication No. GB 252047 A and Borer, 2014, Non-linear opto-electrical transfer functions for high dynamic range television, Research and Development White Paper, British Broadcasting Corporation (24 pages), both incorporated by reference. According to research and theory, using a logarithmic or approximately logarithmic transfer function, as compared to ITU-R BT 709 as shown in FIG. 5, an HDR stream is convertible (reversibly) into an 8 bit video signal that can be transmitted over 8 bit channels and converted back into HDR by the inverse function within a display/receiver device, which can then display the HDR video.

Embodiments of the method 101 are implemented in a camera such as a real-time HDR video camera.

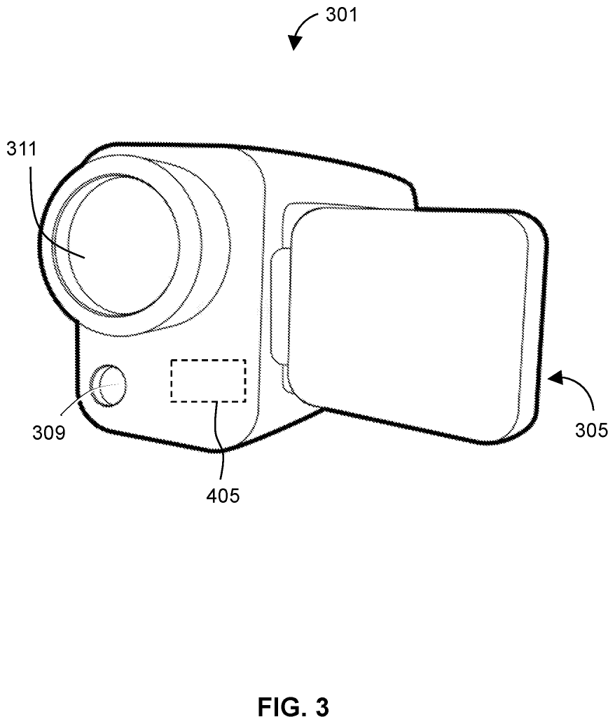

FIG. 3 shows a video camera 301. The video camera 301 may include features such as an input/output device 305 such as a screen or touch-screen facing a user, a lens element 311 to receive an image-forming beam, and a circuit board 405 mounted within, such as printed circuit board (PCB) having connected thereto electronic features such as processor and/or memory chips. The camera 301 may further include any suitable optional features such as a light sensor 309. Preferably within the camera 301, behind the lens 311 is at least one image sensor connected to a processing device that receives pixel values from the image sensor. In real-time HDR camera embodiments, the method 101 includes receiving light 107 e.g., through the lens 311. An optical splitting system is used to take, by multiple sensors, multiple image inputs, in the form of streams of pixel values, that are optically identical except for light level. Those pixel streams are merged to form HDR video. The merging 115 may be performed on a processing device on the printed circuit board 405. The method 101 preferably includes transmitting the outputs to a receiver or writing 125 the outputs to memory such as an SD card.

The camera 301 may be useful for taking real-time HDR video with a reversible dynamic transfer function. In some embodiments, the real-time HDR video is formed and/or the transfer function is implemented dynamically within a pixel processing pipeline on processing devices on the circuit board 405.

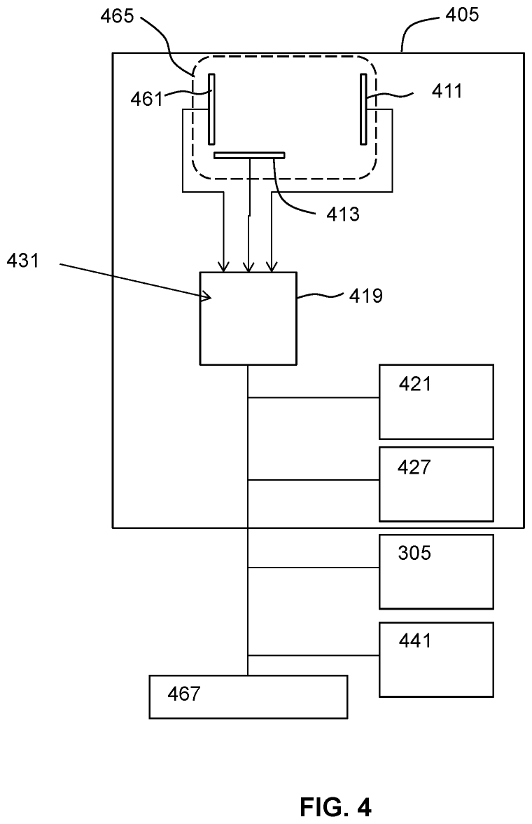

FIG. 4 shows the circuit board 405 of a camera 301 (e.g., a high dynamic range video camera) that includes at least one image sensor 411 coupled to a processing device 419 such as a field-programmable gate array (FPGA) or an application-specific integrated circuit (ASIC). A plurality of image sensors 465 may be coupled to the processing device 419 (three are shown, but one could be omitted for a two-sensor embodiment; the plurality could also include 4, 5, or more sensors). As shown, the plurality of sensors 465 includes a first sensor 411, a second sensor 413, and a third sensor 461. Preferably, the different sensors receive light at different levels to simultaneously form images that are optically identically except for light level, i.e., a bright version of a picture and at least one second image that is a less bright version of the picture. The camera 301 is operable to stream pixel values from each of the plurality of image sensors 465 in a frame-independent manner through a pipeline 431 on the processing device 419. The pipeline 431 may include an HDR function that combines the streaming pixel values in real-time into an HDR video stream and a transfer function that converts the HDR video stream to an SDR-compatible video stream. Various components of the camera may be connected via the printed circuit board 405. The camera 301 may also include memory 421 and optionally a control processor 427 (such as a general-purpose processor like an Intel chip). The camera 301 may further include one or more of an input-output device 305 and may further be connectable to a display 467 (any one of the I/O devices 305 may itself be or include a display such as an LCD screen on the camera 301) and an external storage device 441. The at least one sensor 411 may be provided as part of an optical splitting system that includes the plurality 465 of sensors.

FIG. 5 shows the optical splitting system 500 and an arrangement of the plurality 465 of sensors, the lens 311, and at least one asymmetric beamsplitter 501. The plurality 465 of sensors preferably include at least a first (HE) sensor 513 and a second (ME) sensor 511 in which the second ME sensor receives a lower quantity of light than the first sensor 513 and takes an image signal at a lower light level than the first sensor. As shown, there is a third (LE) sensor 561 that receives a lower quantity of light than the first and second sensors 511, 513 and takes an image signal at a lower light level than those sensors. The light path length to each sensor is the same and each image is optically identical except for illumination intensity. Each image sensor may have its own color filter array 507. The color filter arrays 507 may operate as a Bayer filter such as a repeating grid of red, green, blue, green filters. The optical splitting system 500 preferably includes a lens 311 and at least one asymmetric beamsplitter 501. The HE sensor 513, the ME sensor 411, the lens 311 and the at least one beamsplitter 501 are arranged to receive an incoming beam of light 505 and split the beam of light 505 into at least a first path that impinges and HE sensor 513 and a second path that impinges on the ME sensor 411.

The camera 301 may use a set of partially-reflecting surfaces to split the light from a single photographic lens element 311 so that it is focused onto two or more imaging sensors simultaneously. In a preferred embodiment, the light is directed back through one beamsplitter 501 a second time, and the three sub-images are optically identical except for their light levels. The optical splitting system 500 allows the camera 301 to capture HDR images using most of the light entering the camera. Generally, the camera 301 will include analog-to-digital converters and when light 505 impinges upon the sensors 411, 513, pixel values will stream onto the processor device 419. The camera may include at least one asymmetric beamsplitter 501 that splits an image-forming beam asymmetrically (e.g., light level percent ratios such as 94/6 or 90/10 or 80/20) onto multiple image sensors to thereby receive multiple image inputs that are optically identical except for light level,

In some embodiments, the optical splitting system 500 uses two uncoated, 2-micron thick plastic beamsplitters that rely on Fresnel reflections at air/plastic interfaces so their actual transmittance/reflectance (T/R) values are a function of angle. Glass is also a suitable option. Other options include crystal or glass cubes with a 45 degree angle face with a beampslitting coating bisecting the cube, or pellicle membrane beamsplitters. In one embodiment, the first beamsplitter 501 is at a 45 degree angle to the beam 505 and has an approximate T/R (transmit-to-reflect) ratio of 92/8, which means that 92% of the light from the camera lens 311 is transmitted through the first beamsplitter 501and focused directly onto the high-exposure (HE) sensor 513. The beamsplitter 501 reflects 8% of the light from the lens 311 upwards, toward the second uncoated beamsplitter 519, which has the same optical properties as the first but is positioned at a 90° angle to the light path and has an approximate T/R ratio of 94/6.

Of the 8% of the total light that is reflected upwards, 94% (or 7.52% of the total light) is transmitted through the second beamsplitter 519 and focused onto the medium-exposure (ME) sensor 411. The other 6% of this upward-reflected light (or 0.48% of the total light) is reflected back down by the second beamsplitter 519 toward the first beamsplitter 301 (which is again at 45.), through which 92% (or 0.44% of the total light) is transmitted and focused onto the low-exposure (LE) sensor 561. With this arrangement, the HE, ME and LE sensors capture images with 92%, 7.52%, and 0.44% of the total light gathered by the camera lens 311, respectively. Therefore, the HE and ME exposures are separated by 12.2× (3.61 stops) and the ME and LE are separated by 17.0× (4.09 stops), which means that this configuration is designed to extend the dynamic range of the sensor by 7.7 stops.

This beamsplitter arrangement makes the camera 301 light efficient: a negligible 0.04% of the total light gathered by the lens 311 is wasted. It also allows all three sensors to “see” the same scene, so all three images are optically identical except for their light levels. Of course, the ME image has undergone an odd number of reflections and so it is flipped left-right compared to the other images, but this is fixed easily in software. In preferred embodiments, the three sensors are not gen-locked and instead independently stream incoming pixel values directly into a pipeline that includes a synchronization module. This avoids the requirement for a clock or similar triggering apparatus.

Thus it can be seen that the beamsplitter 501 directs a majority of the light to the first path and a lesser amount of the light to the second path. Preferably, the first path and the second path impinge on the HE and the ME sensor 411, respectively, to generate images that are optically identical but for light level. In the depicted embodiment, the camera 301 includes a low exposure (LE) sensor.

In preferred embodiments, the HE sensor 513, the ME sensor 511, and the LE sensor 561 are not gen-locked. Pixel values stream from the sensors in sequences directly to the processing device 419. Those sequences may be not synchronized as they arrive onto the processing device 419.

The method 101 may include receiving 107 incoming light through the lens 311 and splitting the light via at least one beamsplitter 501 onto the multiple image sensors, wherein at least 99% of the incoming beam of light 505 is captured by the multiple image sensors.

The camera 301 (1) captures optically-aligned, multiple-exposure images simultaneously that do not need image manipulation to account for motion, (2) extends the dynamic range of available image sensors (by over 7 photographic stops in our current prototype), (3) is inexpensive to implement, (4) utilizes a single, standard camera lens 311, (5) efficiently uses the light from the lens 311, and (6) applies a dynamic OETF to provide a digital video in real time (by pipeline processing) with no visible contouring and high dynamic range.

The plurality 465 of image sensors may have the depicted arrangement on the printed circuit board 405 and the pixel values from the sensor 411 and the other sensors of the plurality may stream to the processing device 419. The processing device 419 includes a pipeline that processes the pixel values in a frame independent manner. Frame independent means or includes implementations in which no entire frame's worth of pixels is stored at any location on the printed circuit board 405 prior to the pipeline processing such that merging and/or the transfer function may be performed on individual pixel values without the camera 301 having yet stored any complete image from the sensor 411 in any location between the sensor and the output of the pipeline. In such embodiments, the camera does not need any frame grabber or frame buffer and—as discussed below—HDR video may be formed and/or gamma correction (a type of encoding) may be applied (and the transfer function may be re-defined) without storing or operating on any entire frame of an image from the sensor 411. The functionality of providing a dynamic (i.e., on-the-fly changeable) transfer function is provided by applying the transfer function to the pixel values within the pipeline that is implemented on the processing device 419.

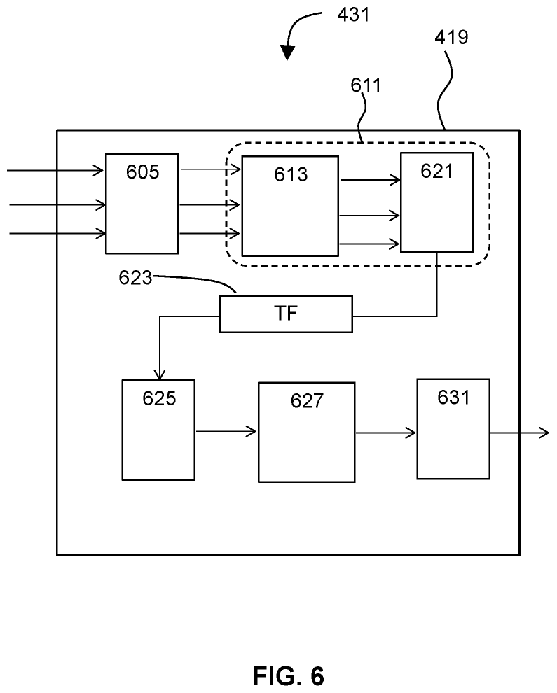

FIG. 6 shows the pipeline 341 on the processing device 419 on the camera 301. Pixel values from the sensors stream through the pipeline 431 on the processing device 419. The pipeline 431 may include a sync module 605 to synchronize the pixel values as the pixel values stream onto the processing device 419 from the plurality of image sensors 465. The pipeline includes an HDR function 611 that combines the streaming pixel values in real-time into an HDR video stream, and a transfer function 623 that converts the HDR video stream to an SDR video stream. In preferred embodiments, the HDR function includes a kernel operation 613 and a merge module 621. The kernel operation 613 identifies saturated pixel values and the merge module merges the pixel values to produce an HDR stream. The pipeline may further include a demosaicing module 625, a tone-mapping operator 627, one or more auxiliary module 631 such as a color-correction module, or combinations thereof. In the depicted embodiment, the camera 301 merges, within the pipeline 431 on the processing device 419, the multiple image inputs in frame-independent manner to form a real-time HDR video. In the preferred embodiments, the input signal is converted to outputs according to the transfer function, and that conversion is performed in a frame-independent manner within the pipeline 431.

The transfer function 623 is depicted as a module on the processing device 419 (e.g., FPGA or ASIC). In some embodiments, the transfer function 623 gives effect on the processing device 419, but also communicates with a general processing chip, aka a CPU, that operates as a control processor 427. The control processor 427 may be the, e.g., Intel or AMD chip that generally executes the operating system of the camera. The control processor 427 can receive defining parameters for the transfer function (e.g., a new value for gamma) and pass the parameters to the processing device 419. Here, the transfer function 623 is depicted as downstream of the HDR function 611 but any other suitable order may be used.

In preferred embodiments, the kernel operation 613 operates on pixel values as they stream from each of the plurality 465 of image sensors by examining, for a given pixel on the HE sensor, values from a neighborhood of pixels surrounding the given pixel, finding saturated values in the neighborhood of pixels, and using information from a corresponding neighborhood on the ME sensor to estimate a value for the given pixel. Alternatively, the pipeline 431 may include—in the order in which the pixel values flow: a sync module 605 to synchronize the pixel values as the pixel values stream onto the processing device from the plurality of image sensors; the HDR function 611 comprising the kernel operation 613 and the merge module 621; a demosaicing module 625; a tone-mapping operator 627; and the transfer function 623.

By using the pipeline processing described above, in which incoming light is passed through a single lens and split onto multiple sensors to begin streaming parallel streams of HE and ME (and optionally LE) pixels into an HDR function (e.g., one or more blocks on an FPGA) and a transfer function, HDR video can be captured, broadcast, and displayed live, meaning that live broadcasts can be performed according to existing understandings of the meanings of live broadcasting or in real-time, and in HDR. In preferred embodiments, the HDR video stream comprises HDR pixel values with light levels encoded at greater than 8 bits per color, per pixel, and the SDR video stream comprises SDR pixel values with light levels encoded at a lesser number (such as 8) bits per color, per pixel. The HDR function and the transfer function are performed in real-time on the streaming pixel values such that the SDR video stream can be received and displayed by a receiver as a live broadcast.

The output that gets broadcast is an HDR video signal because the method 101 and the camera 301 use multiple sensors at different exposure levels to capture multiple isomorphic images (i.e., identical but for light level) and merge them. In a simplified manner of speaking, data from a high exposure (HE) sensor are used where portions of an image are dim and data from a mid-exposure (ME) (or lower) sensor are used where portions of an image are more brightly illuminated. The method 101 and camera 301 merge the HE and ME (and optionally LE) images to produce an HDR video signal. Specifically, the method 101 and the camera 301 identify saturated pixels in the images and replace those saturated pixels with values derived from sensors of a lower exposure. In preferred embodiments, a first pixel value from a first pixel on one of the image sensors is identified as saturated if it is at least 90% of a maximum possible pixel value. The HDR function and the transfer function are done by pipeline processing on a pixel-by-pixel basis while the streaming and transmitting steps are performed simultaneously so that the camera captures the video of a live event for display by the receiver as live playback.

In the HDR stream, HDR pixels may have more than 8 bits per color and after application of the transfer function the SDR video stream comprises SDR pixels that use a lesser number, for example 8, bits per pixel value. The transfer function may be a block, or module, on the processing device 419 (e.g., FPGA) that takes dynamic updates from the control processor 427 and applies an optical-electrical transfer function (OETF) (e.g., modifying the gamma function) to a input signal, e.g., a stream of pixels, to convert a video stream with >8 bits per color to an output video stream with fewer bits per color. Preferably the transfer function defines output digital values for corresponding input values according to a function that can be changed within the camera, e.g., by a user defining a new transfer function. Methods may include applying the inverse EOTF at the other end of the transmission to convert the lower number of bits (for example, 8) per color video signal into a full >8 bits signal.

For example, a video stream may have 14 bits per color, and be subject to a specific S-log transfer function (in a pipeline process, pixel-by-pixel) to convert each pixel to 8-bits per color. Then this 8-bit video signal is sent via a standard 8-bit television, cable, or satellite channel to a receiver, where the receiver would apply an inverse EOTF to produce a 14-bit signal which is displayed on a special 14-bit display. In some embodiments, the transfer function applies s-log encoding, in order to encode HDR video data in the camera (which may capture at 14- or even 16-bits per color per pixel) down to 8 bits per color per pixel. The resultant 8-bit signal is transmitted over a typical 8-bit broadcast TV channel (cable, satellite, over-the-air). The inverse process (s-log expansion) restores the video to its original 14- or 16-bits per color per pixel for display on an HDR TV monitor.

Various components of the camera 301 may be connected via a printed circuit board 405. The camera 301 may also include memory 421 and optionally a control processor 427 (such as a general-purpose processor like an Intel chip). The camera 301 may further include one or more of an input-output device 305 or a connected display 467. Memory can include RAM or ROM and preferably includes at least one tangible, non-transitory medium. The control chip 427 may be any suitable processor known in the art, such as the processor sold under the trademark XEON E7 by Intel (Santa Clara, Calif.) or the processor sold under the trademark OPTERON 6200 by AMD (Sunnyvale, Calif.). Input/output devices according to the invention may include a video display unit (e.g., a liquid crystal display or LED display), keys, buttons, a signal generation device (e.g., a speaker, chime, or light), a touchscreen, an accelerometer, a microphone, a cellular radio frequency antenna, port for a memory card, and a network interface device, which can be, for example, a network interface card (NIC), Wi-Fi card, or cellular modem. The camera 301 may include or be connected to a storage device 441 (e.g., SD card or internal or external SSD drive). The plurality of sensors are preferably provided in an arrangement that allows multiple sensors 465 to simultaneously receive images that are identical except for light level.

In some embodiments, the processing device 419 is coupled to a control chip 427 communicating with an input/output (I/O) device 305, the control chip 427 comprising a software module that passes user-defined transfer function parameters to the processing device 419, whereby the processing device 419 converts an analog scene luminance input signal to digital outputs according to the user-defined transfer function parameters. The processing device 419 may be coupled to the control chip 427, e.g., on a PCB 405 housed within the video camera 301. The camera 301 includes at least one input/output (I/O) device 305 by which a user can provide input re-defining the transfer function. The control chip 427 passes transfer function parameters to the processing device 419, and the processing device 419 converts an analog video input signal to digital outputs according to the transfer function parameters. The processing device 419 may be a field-programmable gate-array (FPGA). The video camera 301 may include a lens 311 and one or more image sensors 411 coupled to the FPGA. The control chip 427 may include a software module for interacting with the user via the I/O device to re-define the transfer function. The method 101 preferably (1) combines images separated by more than 3 stops in exposure from the next higher- and/or lower-exposure image, (2) spatially blends predemosaiced pixel data to reduce unwanted artifacts, (3) produces an HDR stream with >8-bits of depth per color per pixel that is radiometrically correct, (4) uses the highest-fidelity (lowest quantized-noise) pixel data available, and (5) applies a lower bit-depth (for example, 8-bit) S-log or similar transfer function. The apparatus 201 can work with a variety of different sensor types and uses an optical architecture based on beamsplitters located between the camera lens and the sensors.

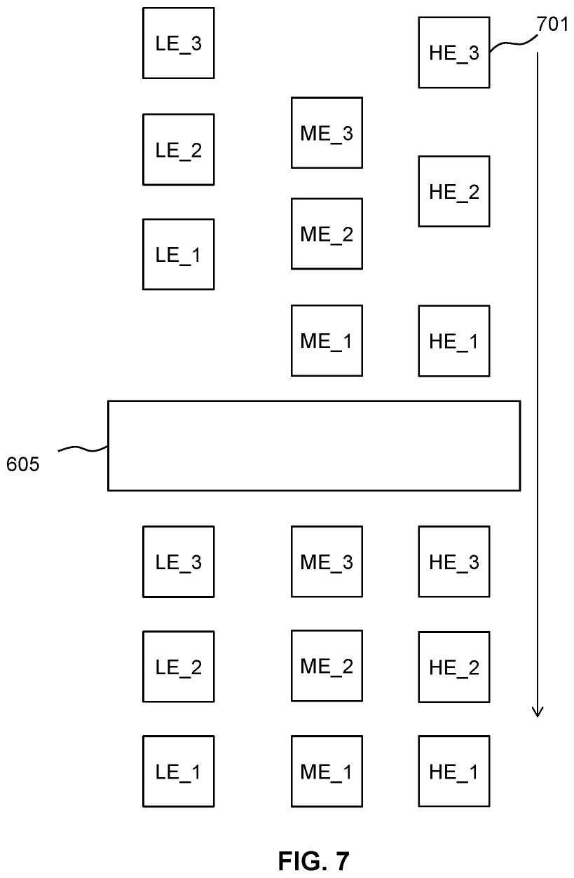

FIG. 7 shows operation of the sync module 605 to synchronize the pixel values 701 as the pixel values 701 stream onto the processing device 419 from the plurality of image sensors 465. The HE_1 pixel value and ME_1 pixel value are arriving at the sync module 605 approximately simultaneously. However, HE_2 pixel value will arrive late compared to ME_2, and the entire sequence of LE pixel values will arrive late. The sync module 605 can contain small line buffers that circulate the early-arriving pixel values and release them simultaneous with the corresponding later-arriving pixel values. The synchronized pixel values then stream through the pipeline 431 to the kernel operation 613.

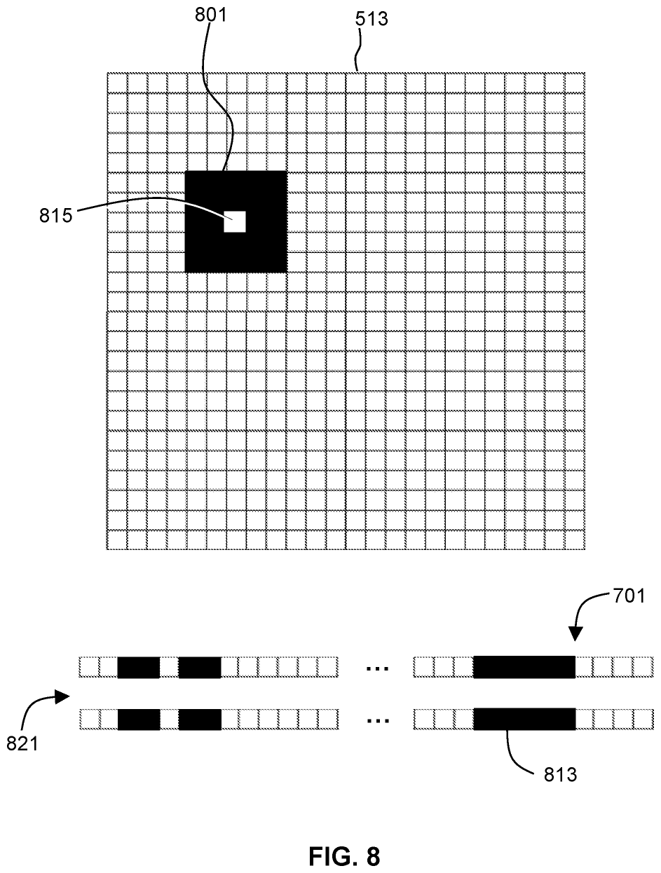

FIG. 8 illustrates how the pixel values are presented to the kernel operation 613. The top part of the figures shows the HE sensor 513. Each square depicts one pixel of the sensor 513. A heavy black box with a white center is drawn to illustrate a given pixelsite 815 for consideration and a neighborhood 801 of pixels surrounding the given pixel 815. The heavy black box would not actually appear on a sensor 513 (such as a CMOS cinematic camera sensor)—it is merely drawn to illustrate what the neighborhood 801 includes and to aid understanding how the neighborhood 801 appears when the sequences 821 of pixel values 701 are presented to the kernel operation 613. The sequences 821 of pixel values stream into the kernel operation 613 after the sync module 605. Pixel values 701 from the neighborhood 801 of pixels on the sensor 513 are still “blacked out” to aid illustration. The given pixel 815 under consideration can be spotted easily because it is surrounded on each side by two black pixels from the row of pixels on the sensor. There are two sequences 821, one of which comes from the depicted HE sensor 513 and one of which originates at the ME sensor 411.

Streaming the pixel values 701 through the kernel operation 613 includes examining values from a neighborhood 801 of pixels surrounding a first pixel 815 on the HE sensor 513, finding saturated values in the neighborhood 801 of pixels, and using information from a corresponding neighborhood 813 from the ME sensor 411 to estimate a value for the first pixel 815. This can include simply selecting the lower-exposure sensor value when the neighborhood on the higher exposure sensor has a threshold number of saturated pixel values. Estimating the value may be as described in U.S. Pat. Nos. 10,742,847 or 10,257,393, incorporated by reference. To accomplish this, the processing device must make comparisons between corresponding pixel values from different sensors. It may be useful to stream the pixel values through the kernel operation in a fashion that places the pixel under consideration 815 adjacent to each pixel from the neighborhood 801 as well as adjacent to each pixel from the corresponding neighborhood on another sensor. For background, see Bravo, 2011, Efficient smart CMOS camera based on FPGAs oriented to embedded image processing, Sensors 11:2282-2303; Lyu, 2014, A 12-bit high-speed column parallel two-step single-slope analog-to-digital converter (ADC) for CMOS image sensors, Sensors 14:21603-21625; Ab Rahman, 2011, Pipeline synthesis and optimization of FPGA-based video processing applications with CAL, EURASIP J Image Vid Processing 19:1-28; Schulte, 2016, HDR Demystified: Emerging UHDTV systems, SpectraCal 1-22; U.S. Pub. 2017/0237890; U.S. Pub. 2017/0238029; and U.S. Pat. No. 8,982,962 to Gish, the contents of each of which are incorporated by reference.

The invention provides methods for the real-time, dynamic reversible encoding of high dynamic range videos, allowing high dynamic range videos to be broadcast through standard dynamic range channels. A high-dynamic range video signal is streamed through a pipeline that processes the video stream in a pixel-by-pixel manner as the pixels stream through the pipeline. The pipeline includes a dynamic transfer function that can decrease a number of bits of each pixel to a standard dynamic range, in a reversible manner, to allow the high dynamic range video to be transmitted over existing, standard dynamic range channels. The transfer function may also be edited or changed while the methods and devices operate. For example, the transfer function may be switched between pre-sets, or the transfer function may be edited by a user in a free-form manner. For example, a camera may have a touch screen that displays a shape of a transfer function and allows a user to touch-and-drag the shape to thereby re-define the transfer function accordingly. The transfer function may be, for example, by default an opto-electrical transfer function (OETF) such as S-Log that converts pixels from greater than 8 bits per color to at most 8 bits per color, and the inverse function may be applied by a receiver such as a display device to display the video with high dynamic range.

The processer process pixels in a pipeline in real-time to form the high dynamic range video. Pipeline processing of the pixels as they stream through the processor provides a high dynamic range (HDR) pixel stream and also uses the OETF to decrease the number of bits per pixel as the pixels stream through the pipeline in a frame-independent manner, allowing the live video to be captured and broadcast for display in real-time. Because the transfer function reversibly decreases the number of bits per pixel, methods are useful for reversibly encoding live high dynamic range video signal for transmission over standard dynamic range channels. After transmission over standard dynamic range channels, the encoded signal may be displayed at the low dynamic range or transformed back into, and displayed at, the high dynamic range.

The method 101 may include re-defining the transfer function multiple times while the processing device is continuously streaming a live video. For example, a light sensor 309 on the camera 301 may read an ambient light level and the processing device may redefine the transfer function to automatically adjust the transfer function definition according to the light level. Whether automatically or by user input, the transfer function may be re-defined while the video camera 301 is continuously capturing a live video.

In some embodiments, the camera 301 includes an I/O device 305 such as a screen, knob, or switch that displays a pre-selected set of curves for selection by the user.

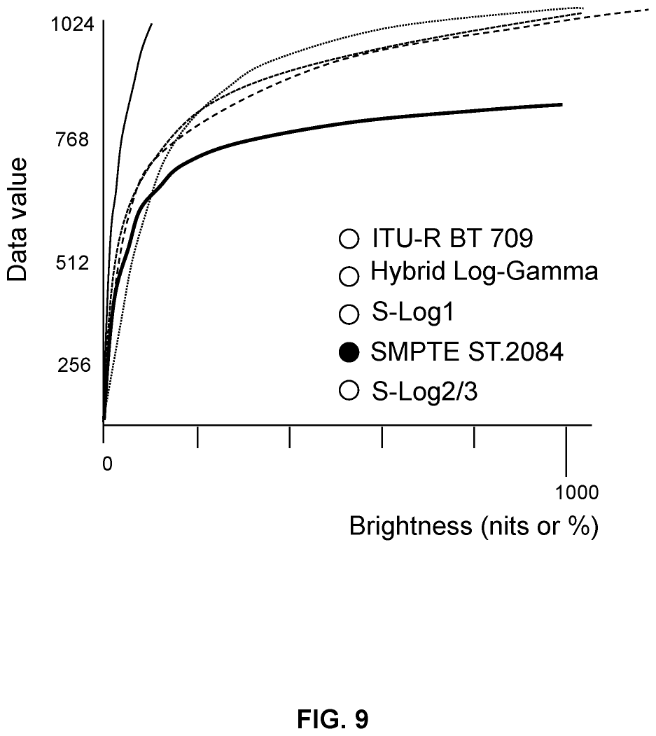

FIG. 9 shows a display on an I/O device 305 through which a user may select from a pre-selected set of curves. In the depicted embodiment, the I/O device 305 comprises a touch screen preview monitor that shows the following pre-selected set of curves: ITU-R BT-709, Hybrid Log-Gamm, S-Log1, SMPTE ST.2084, and S-Log2/3. The screen may also include radio buttons by which the user selects a curve. Upon selection of one curve by the user, the video camera 301 implements the transfer function according to the selected curve.

Preferably, the camera 301 is operable to redefine the transfer function multiple times while the processing device 419 is continuously streaming a live video. In some embodiments, the user custom-defines the transfer function through a screen on the camera on which screen the user draws or edits a curve.

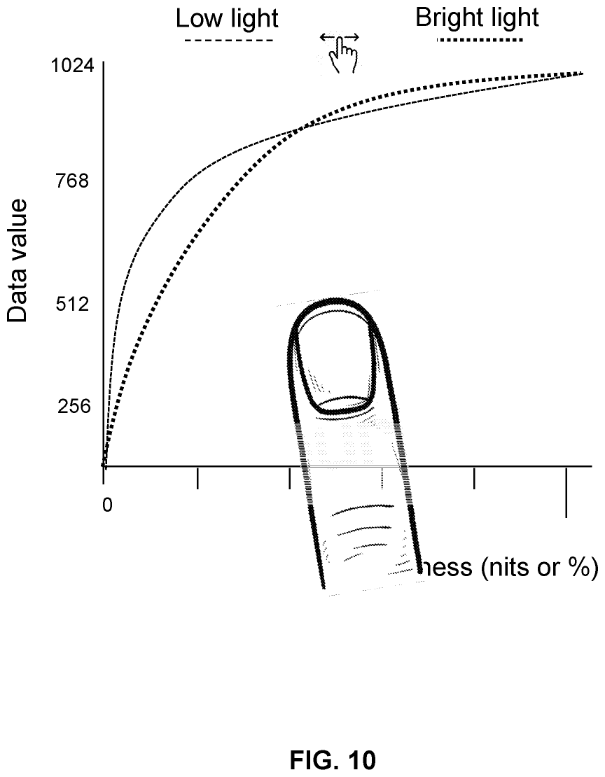

FIG. 10 shows an embodiment in which an I/O device 305 is a touch screen on which a user may custom-define the transfer function. Moreover, the camera 301 displays some guidance to help the user decide how to define the transfer function. In the depicted embodiment, the computer displays a swipe icon suggesting that the user can use the touch screen to drag the transfer function curve into new a shape. Here, over the left-most portion of the x-axis, the slope of the transfer function essentially defines what quantity, or range, of data values will be allocated to low-luminance input signals. In very low light (or if the user is concerned about reproducing detail in a darkly-lit portion of the scene), the user may want a very steep initial slope so that low-lit pixels get encoded over a great range of bit values. Conversely, for a brightly lit scene, the user may want more of the data values allocated over the higher brightness values. The user can (in some embodiments) drag the transfer function curve from one shape to another, or (in other embodiments) free-trace a transfer function curve onto the touch screen. The resultant custom transfer function curve is dynamically implemented in the underlying transfer function 623 on processing device 419 as an optical-electrical transfer function that receives scene luminance as the input signal and outputs, e.g., 8-bit pixel values. Here, the transfer function is dynamically re-defined according to user input to allocate a greater range of output pixel values across a range of low-luminance input values (or vice-versa).

### Incorporation by Reference

References and citations to other documents, such as patents, patent applications, patent publications, journals, books, papers, web contents, have been made throughout this disclosure. All such documents are hereby incorporated herein by reference in their entirety for all purposes.

### Equivalents

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

1. A method for image enhancement, the method comprising the steps of obtaining input image pixel data;
identifying one or more portions of said image for enhancement;
modulating a transfer function to produce output pixel data in which said portions are assigned a larger number of output pixel values and one or more remaining portions are assigned a smaller number of output pixel values; and
displaying said image.

2. (canceled)

3. A method comprising:
receiving an input signal in a processing device; and
converting the input signal into outputs according to a transfer function resident on the processing device, wherein the transfer function defines a relationship from input to output values and wherein the transfer function relationship can be dynamically changed during said converting step.

4. The method of claim 3, wherein the transfer function is non-linear function.

5. The method of claim 4, wherein said non-linear function is logarithmic.

6. The method of claim 5, wherein the logarithmic relationship includes output=offset+constant*(input)\hat{ }gamma, and the processing device can receive a new gamma and/or a new constant and/or a new offset to redefine the relationship.

7. The method of claim 3, wherein the processing device is coupled to a control processor housed within a video camera comprising at least one input/output (I/O) device by which a user can provide input re-defining the transfer function, wherein the control processor passes transfer function parameters to the processing device, and wherein the processing device converts an analog video input signal to digital outputs according to the transfer function parameters.

8. The method of claim 7, wherein the processing device is a field-programmable gate-array (FPGA), and the video camera further comprises at least one lens and an image sensor coupled to the FPGA, and the control processor includes a software module for interacting with the user via the I/O device to re-define the transfer function.

9. The method of claim 1, wherein the modulating step comprises modulating the transfer function multiple times while the processing device is continuously streaming a live video.

10. The method of claim 1, further comprising modulating the transfer function according to logic on the processing device that reads an ambient light level and automatically adjusts the transfer function definition according to the light level.

11. The method of claim 1, wherein the transfer function is an optical-electrical transfer function that receives scene luminance as the input signal and outputs 8-bit pixel values, the method further comprising re-defining the transfer function according to user input to allocate a greater range of output pixel values across a range of low-luminance input values.

12. The method of claim 3, further comprising modulating the transfer function according to logic on the processing device that reads an ambient light level and automatically adjusts the transfer function definition according to the light level.

13. The method of claim 3, wherein the transfer function is an optical-electrical transfer function that receives scene luminance as the input signal and outputs 8-bit pixel values, the method further comprising re-defining the transfer function according to user input to allocate a greater range of output pixel values across a range of low-luminance input values.

14. The method of claim 1 or 3, wherein the method is implemented by a video camera comprising an input/output (I/O) device by which a user may re-define the transfer function while the video camera is continuously capturing a live video.

15. The method of claim 14, wherein a pre-selected set of curves includes one or more of ITU-R BT-709, S-Log3, SMPTE ST.2084, and a hybrid Log-Gamma curve and wherein upon selection of one curve by the user, the video camera implements the transfer function according to the selected curve.

16. The method of claim 1 or 3, wherein the method is implemented within a video device comprising an input/output (I/O) device by which a user may custom-define the transfer function, optionally wherein the I/O is a screen on the video device or a connection to a user terminal on which the user draws or edits a curve.

17. The method of claim 1 or 3, wherein the method is performed by a high-dynamic range (HDR) camera that includes the processing device, the method further comprising:
receiving, simultaneously through at least one asymmetric beamsplitter and multiple image sensors in the camera, multiple image inputs that are optically identical except for light level, and
merging, within a pipeline on the processing device, the multiple image inputs in frame-independent manner to form a real-time HDR video, wherein the converting according to the transfer function is performed in a frame-independent manner within the pipeline.

18. A camera comprising:
at least one image sensor;
a processing device that receives pixel values from the image sensor; and
a module on the processing device that converts the pixel values to digital values according to a transfer function, wherein the transfer function defines output digital values for corresponding input values according to a function that can be changed within the camera while the camera is in use.

19-28. (canceled)
